(19) United States
(12) Patent Application Publication
(10) Pub. No.: US 2026/0177869 A1
(43) Pub. Date: Jun. 25, 2026

(54) DISPLAY DEVICE

(71) Applicant: Japan Display Inc., Tokyo (JP)

(72) Inventor: Hirotaka HAYASHI, Tokyo (JP)

(21) Appl. No.: 19/394,073

(22) Filed: Nov. 19, 2025

(30) Foreign Application Priority Data
Dec. 23, 2024 (JP) 2024-225882

(51) Int. Cl. G02F 1/1362; G02F 1/1368; G09G 3/36

(52) U.S. Cl. CPC G02F 1/13624; G02F 1/136213; G02F 1/136286; G02F 1/1368; G09G 3/3614; G09G 2300/0465

(57) ABSTRACT

To provide a technology that can increase an amplitude of a pixel electrode with respect to an amplitude of a source line without reducing the number of pixels in one row in a display device that adopts pixels including a boosting circuit.

In a display device, the number of signal lines is doubled, and signal lines are separately provided for pixels in odd-numbered rows and pixels in adjacent even-numbered rows. Two rows are driven during the time of one horizontal period by simultaneously driving scanning lines in an odd-numbered row and an even-numbered row, and performing writing to pixels in the odd-numbered row and pixels in the adjacent even-numbered row. The one horizontal period can be thereby apparently halved.

### CLAIM OF PRIORITY

The present application claims priority from Japanese Patent Application JP 2024-225882 filed on Dec. 23, 2024, the contents of which is hereby incorporated by reference into this application.

### BACKGROUND OF THE INVENTION

### (1) Field of the Invention

The present disclosure relates to a display device.

### (2) Description of the Related Art

JP-1993-61016-A, for example, has been proposed as a display element using a polymer dispersed liquid crystal (PDLC) material.

### SUMMARY OF THE INVENTION

The present discloser has investigated a transparent display device or what is called a transparent display using a PDLC material. Because of a high voltage applied to the PDLC, the transparent display necessitates a dedicated source driver integrated circuit (IC) for outputting a high-voltage video signal and a dedicated gate driver IC for writing and holding a high voltage. This is a cause of a high cost factor because, for example, a low-voltage IC manufacturing process cannot be used, and a general-purpose source driver IC and a general-purpose gate driver IC cannot be used.

Accordingly, a transparent display has been developed in which the source driver IC provides a normal (general-purpose) video output voltage as it is, and the dedicated source driver IC is rendered unnecessary by creating a boosting circuit within pixels, and raising a range of liquid crystal application voltage.

However, because each pixel includes a boosting circuit, source lines (referred to also as signal lines) and gate lines (referred to also as scanning lines) are increased as compared with an ordinary pixel circuit, and an aperture ratio is decreased because the constituent elements of the pixel are increased. In addition, the time of one horizontal period is lengthened due to boosting driving. As a result, there is a limitation on the number of pixels, a limitation on a frame rate, or the like.

It is an object of the present disclosure to provide a technology that can increase the amplitude of a pixel electrode with respect to the amplitude of a source line without reducing the number of pixels in one row in a display device that adopts pixels including a boosting circuit.

Other of problems and novel features will become apparent from the description of the present specification and the accompanying drawings.

A summary of representatives of the present disclosure will be briefly described as follows.

That is, a display device according to one embodiment includes: a plurality of pixels arranged in a matrix manner; a first scanning line, a second scanning line, a third scanning line, and a fourth scanning line extending in a first direction and arranged in a second direction intersecting the first direction; and a first signal line and a second signal line extending in the second direction and arranged in the first direction. Moreover, in the display device, the plurality of pixels include a first pixel and a second pixel that is adjacent in the second direction to the first pixel; the first pixel includes a first transistor, a second transistor, a third transistor, and a first common electrode and a first pixel electrode sandwiching a liquid crystal, the first common electrode being supplied with a reference potential; a gate of the first transistor is connected to the second scanning line, one of a source and a drain of the first transistor is connected to the first signal line, and other one of the source and the drain of the first transistor is connected to the first pixel electrode via a first capacitive element; a gate of the second transistor is connected to the first scanning line, one of a source and a drain of the second transistor is connected to the first signal line, and other one of the source and the drain of the second transistor is connected to the first pixel electrode; a gate of the third transistor is connected to the first scanning line, one of a source and a drain of the third transistor is connected to other one of the source and the drain of the first transistor, and other one of the source and the drain of the third transistor is connected to the first common electrode; the second pixel includes a fourth transistor, a fifth transistor, a sixth transistor, and a second common electrode and a second pixel electrode sandwiching the liquid crystal, the second common electrode being supplied with the reference potential; a gate of the fourth transistor is connected to the fourth scanning line, one of a source and a drain of the fourth transistor is connected to the second signal line, and other one of the source and the drain of the fourth transistor is connected to the second pixel electrode via a second capacitive element; a gate of the fifth transistor is connected to the third scanning line, one of a source and a drain of the fifth transistor is connected to the second signal line, and other one of the source and the drain of the fifth transistor is connected to the second pixel electrode; and a gate of the sixth transistor is connected to the third scanning line, one of a source and a drain of the sixth transistor is connected to other one of the source and the drain of the fourth transistor, and other one of the source and the drain of the sixth transistor is connected to the second common electrode.

In addition, a display device according to another embodiment includes: a plurality of pixels arranged in a matrix manner; a first scanning line, a second scanning line, and a third scanning line extending in a first direction and arranged in a second direction intersecting the first direction; and a first signal line and a second signal line extending in the second direction and arranged in the first direction. Moreover, in the display device, the plurality of pixels include a first pixel and a second pixel arranged so as to be adjacent to each other in the second direction; the first pixel includes a first transistor, a second transistor, a third transistor, and a first common electrode and a first pixel electrode sandwiching a liquid crystal, the first common electrode being supplied with a reference potential; a gate of the first transistor is connected to the second scanning line, one of a source and a drain of the first transistor is connected to the first signal line, and other one of the source and the drain of the first transistor is connected to the first pixel electrode via a first capacitive element; a gate of the second transistor is connected to the first scanning line, one of a source and a drain of the second transistor is connected to the first signal line, and other one of the source and the drain of the second transistor is connected to the first pixel electrode; a gate of the third transistor is connected to the first scanning line, one of a source and a drain of the third transistor is connected to other one of the source and the drain of the first transistor, and other one of the source and the drain of the third transistor is connected to the first common electrode; the second pixel includes a fourth transistor, a fifth transistor, a sixth transistor, and a second common electrode and a second pixel electrode sandwiching the liquid crystal, the second common electrode being supplied with the reference potential; a gate of the fourth transistor is connected to the third scanning line, one of a source and a drain of the fourth transistor is connected to the second signal line, and other one of the source and the drain of the fourth transistor is connected to the second pixel electrode via a second capacitive element; a gate of the fifth transistor is connected to the second scanning line, one of a source and a drain of the fifth transistor is connected to the second signal line, and other one of the source and the drain of the fifth transistor is connected to the second pixel electrode; and a gate of the sixth transistor is connected to the second scanning line, one of a source and a drain of the sixth transistor is connected to other one of the source and the drain of the fourth transistor, and other one of the source and the drain of the sixth transistor is connected to the second common electrode.

### BRIEF DESCRIPTION OF THE DRAWINGS

FIG. 1 is a circuit diagram of a pixel according to a comparative example;

FIG. 2 is a diagram illustrating a timing diagram of the pixel in FIG. 1;

FIG. 3 is a diagram of assistance in explaining the voltage of a pixel electrode of the pixel in FIG. 1;

FIG. 4 is a diagram illustrating an example of a configuration of a display device according to a first embodiment;

FIG. 5 is a diagram illustrating an example of a configuration of two pixels illustrated in FIG. 4;

FIG. 6 is a diagram illustrating a timing diagram of the display device according to the first embodiment;

FIG. 7 is a diagram illustrating an example of a configuration of a display device according to a second embodiment;

FIG. 8 is a diagram illustrating an example of a configuration of three pixels illustrated in FIG. 7;

FIG. 9 is a diagram illustrating a timing diagram of the display device according to the second embodiment;

FIG. 10A is a diagram schematically illustrating a liquid crystal layer 30 in a transparent state;

FIG. 10B is a diagram schematically illustrating the liquid crystal layer 30 in a scattering state;

FIG. 11A is a sectional view illustrating a display panel PNL in a case where the liquid crystal layer 30 is in the transparent state; and

FIG. 11B is a sectional view illustrating the display panel PNL in a case where the liquid crystal layer 30 is in the scattering state.

### DETAILED DESCRIPTION OF THE PREFERRED EMBODIMENTS

Embodiments of the present disclosure will hereinafter be described with reference to the drawings. It is to be noted that the disclosure is a mere example, and that appropriate changes that those skilled in the art can easily arrive at while maintaining the spirit of the disclosure are naturally included in the scope of the present disclosure. In addition, in order to make the description clearer, the drawings may illustrate the widths, thicknesses, shapes, and the like of respective parts schematically as compared with actual modes. However, these are mere examples, and do not limit the interpretation of the present disclosure.

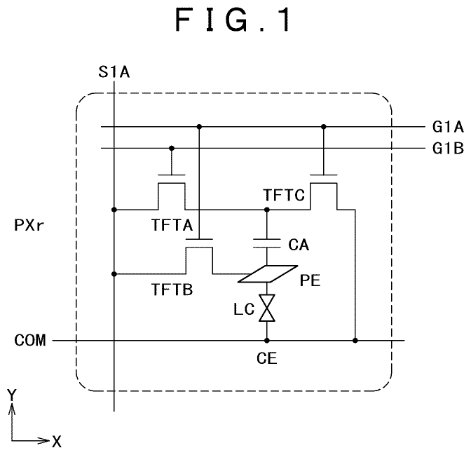

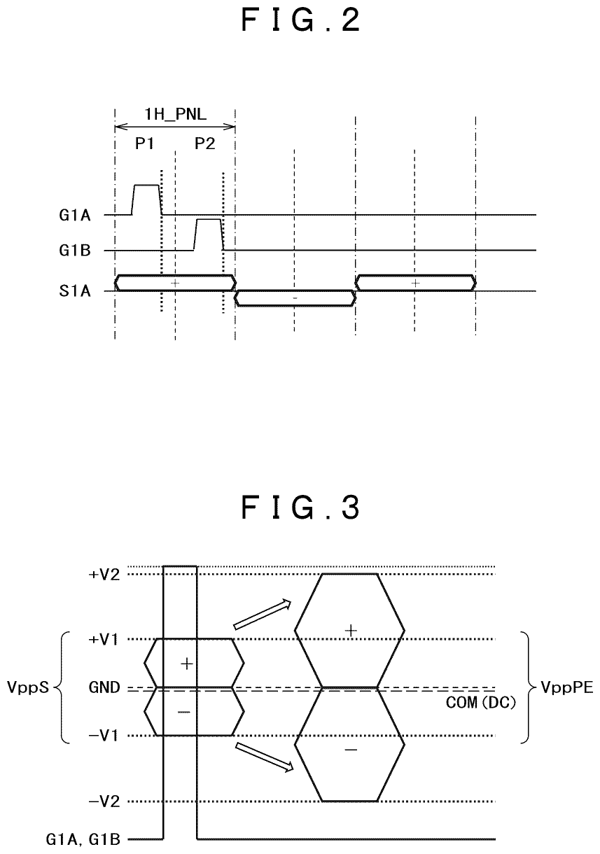

A comparative example will first be described with reference to FIGS. 1 to 3. FIG. 1 is a circuit diagram of a pixel according to the comparative example. FIG. 2 is a diagram illustrating a timing diagram of the pixel in FIG. 1. FIG. 3 is a diagram of assistance in explaining the voltage of a pixel electrode of the pixel in FIG. 1.

A pixel PXr according to the comparative example illustrated in FIG. 1 is a configuration example of one pixel including a boosting circuit (which pixel will be referred to also as a boosting pixel). The pixel PXr is connected to a first scanning line G1A and a second scanning line G1B extending in a first direction X and arranged in a second direction Y intersecting the first direction X, and connected to a first signal line S1A extending in the second direction Y and arranged in the first direction X.

The pixel PXr includes a first transistor TFT-A, a second transistor TFT-B, a third transistor TFT-C, and a common electrode CE and a pixel electrode PE sandwiching a liquid crystal LC, and the pixel PXr is configured such that the common electrode CE is supplied with a reference potential (for example, a ground potential: 0 V) as a common potential VCOM via common potential wiring COM. The first transistor TFT-A, the second transistor TFT-B, and the third transistor TFT-C can be formed by using a thin film transistor (TFT). A PDLC is used as the liquid crystal LC in a transparent display.

A gate of the first transistor TFT-A is connected to the second scanning line G1B. One of a source and a drain of the first transistor TFT-A is connected to the first signal line S1A. The other of the source and the drain of the first transistor TFT-A is connected to the pixel electrode PE via a first capacitive element CA.

A gate of the second transistor TFT-B is connected to the first scanning line G1A. One of a source and a drain of the second transistor TFT-B is connected to the first signal line S1A. The other of the source and the drain of the second transistor TFT-B is connected to the pixel electrode PE.

A gate of the third transistor TFT-C is connected to the first scanning line G1A. One of a source and a drain of the third transistor TFT-C is connected to the other of the source and the drain of the first transistor TFT-A. The other of the source and the drain of the third transistor TFT-C is connected to the common electrode CE.

Timings will be described with reference to FIG. 2. In FIG. 2, a sign − denotes negative polarity with respect to the reference potential, and a sign + denotes positive polarity with respect to the reference potential. In addition, one horizontal period (1H_PNL) of a display panel includes a first half period P1 (referred to also as a first half P1) and a second half period P2 (referred to also as a second half P2). One horizontal period (1H_PNL) of the display panel is, for example, a period in which display data is written to a plurality of pixels of one row in the display panel.

In the first half P1 of one horizontal period (1H_PNL) of the display panel, the first scanning line G1A makes a transition from a low level (non-selected state) to a high level (selected state), and thereby the second transistor TFT-B and the third transistor TFT-C are both set in an on state. At this time, a voltage (+V1: for example, +6.1 V) is written to the capacitive element CA from the first signal line S1A. The first scanning line G1A is thereafter made to make a transition from the high level to the low level.

In the second half P2 of one horizontal period (1H_PNL) of the display panel, the second scanning line G1B makes a transition from a low level (non-selected state) to a high level (selected state), and thereby the first transistor TFT-A is set in an on state. At this time, a voltage (+V1: for example, +6.1 V) is written to the capacitive element CA from the first signal line S1A. Thus, an operation of raising the voltage of the pixel electrode PE is performed by capacitive coupling of the capacitive element CA. The voltage of the pixel electrode PE is, for example, raised (boosted) from +V1 (for example +6.1 V) to +V2 (for example, +14 V). In a case of negative polarity, potentials of opposite polarity to the above are applied, and the voltage of the pixel electrode PE is, for example, lowered (stepped down) to −V2 (for example, −14 V).

Writing to a plurality of pixels of a second row and writing to a plurality of pixels of a third row are sequentially performed after display data is written to the plurality of pixels of the first row in the display panel.

Thus, as illustrated in FIG. 3, a voltage amplitude VppPE of the pixel electrode PE (amplitude between +V2 and −V2) can be increased with respect to a source output amplitude VppS of the source driver IC (amplitude between +V1 and −V1), so that a voltage applied to the liquid crystal LC can be made higher than an output voltage of the source driver IC.

However, in an ordinary pixel circuit, a voltage is written to the pixel electrode once in one horizontal period (1H_PNL). The pixel PXr as a boosting pixel necessitates alternately setting the transistors within the pixel (the first transistor TFT-A as well as the second transistor TFT-B and the third transistor TFT-C) in an on state and an off state in one horizontal period (1H_PNL). There is a heavy load on the scanning line, and alternately setting the transistors (the first transistor TFT-A as well as the second transistor TFT-B and the third transistor TFT-C) in an on state and an off state to write voltages needs a certain time. In addition, alternately making the scanning lines G1A and G1B make a transition from a low level to a high level or from a high level to a low level in one horizontal period (1H_PNL) needs a time equal to that taken to make scanning lines of two rows make a transition from a low level to a high level or from a high level to a low level in the ordinary pixel circuit.

In addition, the driving of the pixel PXr as a boosting pixel needs scanning line switching twice in one horizontal period (1H_PNL), and therefore takes a substantially double time in one horizontal period as compared with the driving of an ordinary pixel (pixel that is not a boosting pixel). Hence, while a higher voltage than the output amplitude of the signal line can be applied to the pixel electrode by using the boosting pixel, one horizontal period is doubled, and therefore the number of stages (number of rows) that can be written to in one frame is halved. Thus, the number of pixels (rows) of the display panel that can be implemented by boosting pixels is halved as compared with a display device that uses ordinary pixels.

In addition, the pixel PXr has problems in that because a boosting circuit is included in a pixel as illustrated in FIG. 1, the scanning lines (second scanning line G1B) are increased as compared with the ordinary pixel circuit, and because the constituent elements (the second transistor TFT-B and the third transistor TFT-C) of the pixel are increased, an aperture ratio is decreased.

In addition, in a case where the display device performs field sequential driving as in the transparent display device, there is such a problem as a shortened lighting time of a light-emitting diode (LED) that irradiates a light entry portion of a transparent light guide plate with light, which transparent light guide plate is provided so as to cover a transparent display section of the transparent display device.

Embodiments will next be described with reference to drawings.

### First Embodiment

The first embodiment is a technology that can increase the number of pixels (rows) to which data is written during the time of one horizontal period (1H_PNL) of the display panel as compared with the comparative example. The number of source lines (signal lines) provided to the display panel is doubled, and, for example, the source lines (signal lines) are separately provided for pixels in odd-numbered rows and pixels in adjacent even-numbered rows. Two rows can be driven during the time of one horizontal period (1H_PNL) by simultaneously driving gate lines (scanning lines) in an odd-numbered row and an even-numbered row, and writing to the pixels. Thus, one horizontal period (1H_PNL) can be apparently halved.

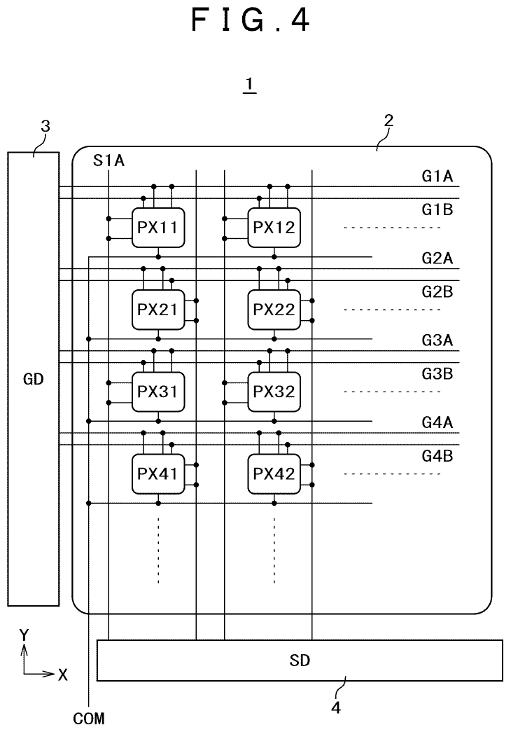

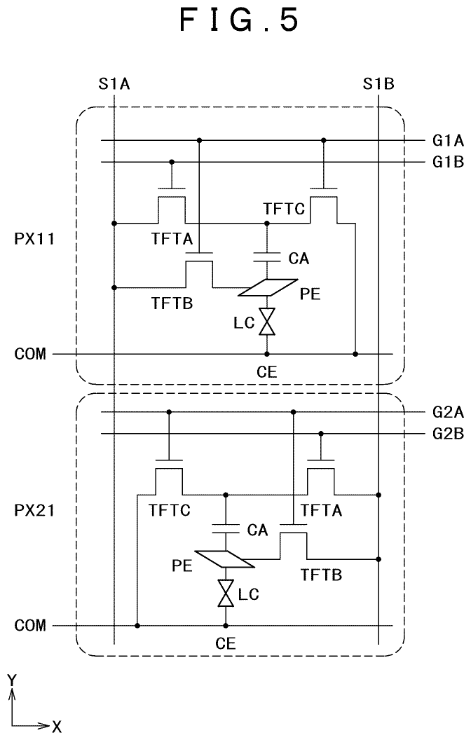

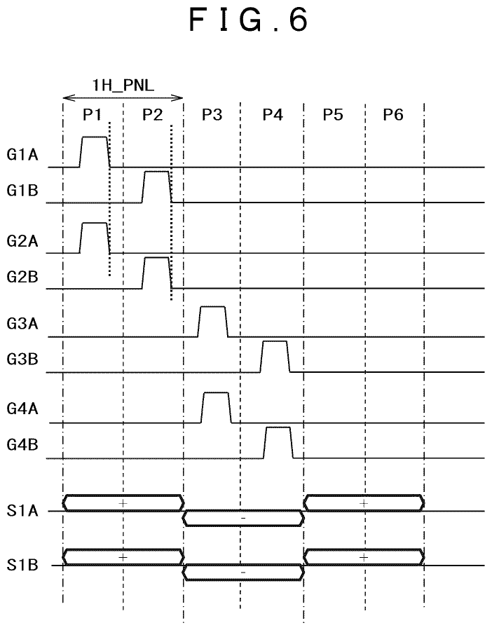

FIG. 4 is a diagram illustrating an example of a configuration of a display device according to the first embodiment. FIG. 5 is a diagram illustrating an example of a configuration of two pixels illustrated in FIG. 4. FIG. 6 is a diagram illustrating a timing diagram of the display device according to the first embodiment.

As illustrated in FIG. 4, the display device 1 includes a display area 2 in which a plurality of pixels PX (PX11, PX12, . . . , PX42) are arranged in a matrix manner (in the form of a matrix), a gate driving circuit (GD) 3, and a signal line driving circuit (SD) 4. The display area 2 may be reworded as a display panel.

The display area 2 includes the plurality of pixels PX and a plurality of scanning lines GL (a first scanning line G1A, a second scanning line G1B, a third scanning line G2A, a fourth scanning line G2B, a fifth scanning line G3A, a sixth scanning line G3B, a seventh scanning line G4A, an eighth scanning line G4B, and the like) extending in the first direction X and arranged in the second direction Y intersecting the first direction X. The plurality of scanning lines GL are connected to the gate driving circuit (GD) 3, and are configured to be driven by the gate driving circuit 3.

In addition, the display area 2 includes a plurality of signal lines SL (a first signal line S1A, a second signal line S1B, a third signal line S2A, a fourth signal line S2B, and the like) extending in the second direction Y and arranged in the first direction X. The plurality of signal lines SL are connected to the signal line driving circuit 4, and are configured to be driven by the signal line driving circuit 4.

Common potential wiring COM is connected to each of the plurality of pixels PX, and is configured to supply a reference potential, for example, a ground potential (0 V).

An example of connections of the plurality of pixels PX to the scanning lines GL and the signal lines SL will be described as a representative example in the following.

The pixels PX11 and PX12 in a first row are connected to the scanning line G1A and the scanning line G1B. The pixel PX11 is connected to the signal line S1A. The pixel PX12 is connected to the signal line S2A.

The pixels PX21 and PX22 in a second row are connected to the scanning line G2A and the scanning line G2B. The pixel PX21 is connected to the signal line S1B. The pixel PX22 is connected to the signal line S2B.

The pixels PX31 and PX32 in a third row are connected to the scanning line G3A and the scanning line G3B. The pixel PX31 is connected to the signal line S1A. The pixel PX32 is connected to the signal line S2A.

The pixels PX41 and PX42 in a fourth row are connected to the scanning line G4A and the scanning line G4B. The pixel PX41 is connected to the signal line S1B. The pixel PX42 is connected to the signal line S2B.

That is, the first embodiment has such a characteristic configuration that in a certain pixel (for example, the first pixel PX11) and another pixel (for example, the second pixel PX21) adjacent in the second direction Y to the certain pixel (first pixel PX11) among the plurality of pixels PX, a connected signal line is the signal line S1A for the certain pixel (for example, the first pixel PX11), and is the signal line S1B, which is different from the signal line S1A, for the another pixel (for example, the second pixel PX21).

FIG. 5 illustrates, as a representation example, an example of a pixel configuration of the first pixel PX11 and the second pixel PX21 adjacent in the second direction Y to the first pixel PX11. Incidentally, the TFTs (TFT-A, TFT-B, and TFT-C) described in the present specification are of an N-channel type. The TFTs are set in an off state when a low level (non-selected state) is applied to the gates thereof. The TFTs are set in an on state when a high level (selected state) is applied to the gates thereof.

The first pixel PX11 includes a first transistor TFT-A, a second transistor TFT-B, a third transistor TFT-C, and a first common electrode CE and a first pixel electrode PE sandwiching a liquid crystal LC. The first common electrode CE is supplied with a reference potential (for example, a ground potential: 0 V) from common potential wiring COM. A capacitive element CA as a first holding capacitor element is connected between the first pixel electrode PE and the first common electrode CE.

A gate of the first transistor TFT-A is connected to the second scanning line G1B. One of a source and a drain of the first transistor TFT-A is connected to the first signal line S1A. The other of the source and the drain of the first transistor is connected to the first pixel electrode (PE) via the first capacitive element CA.

A gate of the second transistor TFT-B is connected to the first scanning line G1A. One of a source and a drain of the second transistor TFT-B is connected to the first signal line S1A. The other of the source and the drain of the second transistor TFT-B is connected to the first pixel electrode PE.

A gate of the third transistor TFT-C is connected to the first scanning line G1A. One of a source and a drain of the third transistor TFT-C is connected to the other of the source and the drain of the first transistor TFT-A. The other of the source and the drain of the third transistor TFT-C is connected to the first common electrode CE.

The second pixel PX21 includes a fourth transistor TFT-A, a fifth transistor TFT-B, a sixth transistor TFT-C, and a second common electrode CE and a second pixel electrode PE sandwiching the liquid crystal LC. The second common electrode CE is supplied with the reference potential (for example, the ground potential: 0 V) from the common potential wiring COM. A capacitive element CA as a second holding capacitor element is connected between the second pixel electrode PE and the second common electrode CE.

A gate of the fourth transistor TFT-A is connected to the fourth scanning line G2B. One of a source and a drain of the fourth transistor TFT-A is connected to the second signal line S1B. The other of the source and the drain of the fourth transistor TFT-A is connected to the second pixel electrode PE via the second capacitive element CA.

A gate of the fifth transistor TFT-B is connected to the third scanning line G2A. One of a source and a drain of the fifth transistor TFT-B is connected to the second signal line S1B. The other of the source and the drain of the fifth transistor TFT-B is connected to the second pixel electrode PE.

A gate of the sixth transistor TFT-C is connected to the third scanning line G2A. One of a source and a drain of the sixth transistor TFT-C is connected to the other of the source and the drain of the fourth transistor TFT-A. The other of the source and the drain of the sixth transistor TFT-C is connected to the second common electrode CE.

Timings will be described with reference to FIG. 6. In FIG. 6, a sign − denotes negative polarity with respect to the reference potential, and a sign + denotes positive polarity with respect to the reference potential. In addition, one horizontal period (1H_PNL) of the display area 2 as a display panel includes a first half period P1 (referred to also as a first period P1) and a second half period P2 (referred to also as a second period P2). FIG. 6 depicts the first period P1, the second period P2 following the first period P1, a third period P3 following the second period P2, and a fourth period P4 following the third period P3. Also depicted following the fourth period are a fifth period P5 following the fourth period P4 and a sixth period P6 following the fifth period P5. The first period P1 and the second period P2 are set as a first horizontal period, for example. The third period P3 and the fourth period P4 are set as a second horizontal period, for example.

In the first period P1 and the second period P2, display data is written to a plurality of pixels in the first row (for example, the first pixel PX11) and a plurality of pixels in the second row (for example, the second pixel PX21). In the third period P3 and the fourth period P4, display data is written to a plurality of pixels in the third row (for example, the third pixel PX31) and a plurality of pixels in the fourth row (for example, the fourth pixel PX41). The following description will be made using the first pixel PX11, the second pixel PX21, the third pixel PX31, and the fourth pixel PX41 as representatives.

In the first period P1, the first scanning line G1A and the third scanning line G2A make a transition from a low level (non-selected state) to a high level (selected state). The second transistor TFT-B and the third transistor TFT-C of the first pixel PX11 are both set in an on state. At this time, a voltage (+V1: for example, +6.1 V) is written to the first capacitive element CA of the first pixel PX11 from the first signal line S1A. In addition, the fifth transistor TFT-B and the sixth transistor TFT-C of the second pixel PX21 are both set in an on state. At this time, a voltage (+V1: for example, +6.1 V) is written to the second capacitive element CA of the second pixel PX21 from the second signal line S1B. The first scanning line G1A and the third scanning line G2A thereafter make a transition from the high level to the low level. The second transistor TFT-B and the third transistor TFT-C of the first pixel PX11 and the fifth transistor TFT-B and the sixth transistor TFT-C of the second pixel PX21 are both set in an off state.

In the second period P2, the second scanning line G1B and the fourth scanning line G2B make a transition from a low level (non-selected state) to a high level (selected state). The first transistor TFT-A of the first pixel PX11 is set in an on state. At this time, a voltage (+V1: for example, +6.1 V) is written to the first capacitive element CA of the first pixel PX11 from the first signal line S1A. The voltage of the first pixel electrode PE is thereby, for example, raised (boosted) from +V1 (for example, +6.1 V) to +V2 (for example, +14 V). In addition, the fourth transistor TFT-A of the second pixel PX21 is set in an on state. At this time, a voltage (+V1: for example, +6.1 V) is written to the second capacitive element CA of the second pixel PX21 from the second signal line S1B. The voltage of the second pixel electrode PE is thereby, for example, raised (boosted) from +V1 (for example, +6.1 V) to +V2 (for example, +14 V). The second scanning line G1B and the fourth scanning line G2B thereafter make a transition from the high level to the low level. The first transistor TFT-A of the first pixel PX11 and the fourth transistor TFT-A of the second pixel PX21 are both set in an off state.

In the third period P3, the fifth scanning line G3A and the seventh scanning line G4A make a transition from a low level (non-selected state) to a high level (selected state). The transistor TFT-B and the transistor TFT-C of the third pixel PX31 are both set in an on state. At this time, a voltage (−V1: for example, −6.1 V) is written to the capacitive element CA of the third pixel PX31 from the first signal line S1A. In addition, the transistor TFT-B and the transistor TFT-C of the fourth pixel PX41 are both set in an on state. At this time, a voltage (−V1: for example, −6.1 V) is written to the capacitive element CA of the fourth pixel PX41 from the second signal line S1B. The fifth scanning line G3A and the seventh scanning line G4A thereafter make a transition from the high level to the low level. The transistor TFT-B and the transistor TFT-C of the third pixel PX31 and the transistor TFT-B and the transistor TFT-C of the fourth pixel PX41 are both set in an off state.

In the fourth period P4, the sixth scanning line G3B and the eighth scanning line G4B make a transition from a low level (non-selected state) to a high level (selected state). The transistor TFT-A of the third pixel PX31 is set in an on state. At this time, a voltage (−V1: for example, −6.1 V) is written to the capacitive element CA of the third pixel PX31 from the first signal line S1A. The voltage of the pixel electrode PE of the third pixel PX31 is thereby, for example, lowered (stepped down) from −V1 (for example, −6.1 V) to −V2 (for example, −14 V). In addition, the transistor TFT-A of the fourth pixel PX41 is set in an on state. At this time, a voltage (−V1: for example, −6.1 V) is written to the capacitive element CA of the fourth pixel PX41 from the second signal line S1B. The voltage of the pixel electrode PE of the third pixel PX31 is thereby, for example, lowered (stepped down) from −V1 (for example, −6.1 V) to −V2 (for example, −14 V). The sixth scanning line G3B and the eighth scanning line G4B thereafter make a transition from the high level to the low level. The transistor TFT-A of the third pixel PX31 and the transistor TFT-A of the fourth pixel PX41 are both set in an off state.

In the fifth period P5 and the sixth period P6, similarly to the above-described operation, display data is written to a plurality of pixels in a fifth row (for example, a fifth pixel PX51) and a plurality of pixels in a sixth row (for example, a sixth pixel PX61).

Writing to each row of the display area 2 of the display device 1 is performed by the operation as described above.

Hence, a summary can be made as follows.

In the first period P1 and the second period P2, a voltage of positive polarity (+) with respect to the reference potential is applied to the first signal line S1A and the second signal line S1B.

In the third period P3 and the fourth period P4, a voltage of negative polarity (−) with respect to the reference potential is applied to the first signal line S1A and the second signal line S1B.

In the first period P1, the first scanning line G1A and the third scanning line G2A make a transition in order of a low level, a high level, and the low level.

In the second period P2, the second scanning line G1B and the fourth scanning line G2B make a transition in order of a low level, a high level, and the low level.

Thus, as described earlier, it is possible to implement pixels including a boosting circuit without reducing the number of pixels (rows), increase the amplitude of the pixel electrode PE with respect to the output amplitude of the source driver IC (signal line driving circuit 4), and consequently raise the voltage applied to the liquid crystal LC.

In the boosting pixels, one horizontal period is twice that of pixels of an ordinary display device. Thus, letting H be one horizontal period of ordinary pixels, in a case where the number of pixels (rows) is y, a time (y×H×2) is necessary for the entire screen.

Doubling the number of signal lines can apparently halve one horizontal period.

Thus, (y×H×2)÷2=(y×H), that is, the same time as that of the ordinary pixels that are not the boosting pixels can be achieved. One horizontal period can therefore be reduced in effect while a writing time is secured.

### Second Embodiment

The boosting pixels PX described in the first embodiment have a configuration including, in one pixel, one signal line, one capacitive element, three transistors, and two scanning lines.

The driving of the boosting pixel is performed so as to set the two transistors TFT-B and TFT-C in an on state and charge the capacitive element CA in the first half (period P1 or P3) of one horizontal period, and set one remaining transistor TFT-A in an on state and raise the voltage of the pixel electrode PE by capacitive coupling in the second half (period P2 or P4) of one horizontal period, so that a voltage higher than the voltage written to the signal line is applied to the pixel electrode PE. In the first embodiment, the driving is performed while the scanning lines are sequentially turned on.

In a second embodiment, two upper and lower pixels adjacent to each other in the second direction Y are made to share a scanning line on one respective side, and share and simultaneously drive the scanning line for the control of the transistor TFT-A for a purpose of raising a pixel voltage PE in the second half (P2) of one horizontal period in a first row and for the control of the two transistors TFT-B and TFT-C for a purpose of charge writing to the capacitive element CA in the first half (P3) of one horizontal period in a next row. It is thereby possible to shorten one apparent horizontal period and achieve an improvement in the aperture ratio by reducing the number of scanning lines.

In the second embodiment, when the scanning line of an (n)th row is set to a high level in the first half (P1) of one horizontal period, the voltage of the signal line (S1A) is written to one side of the capacitance CA of a pixel in the (n)th row, and the voltage (0 V) of the common potential wiring COM is written to another side of the capacitance CA. In the second half (P2) of one horizontal period, the scanning line of an (n+1)th row is set to a high level, the voltage of the signal line (S1A) is written to the electrode side of the capacitance CA as the side to which the voltage (0 V) of the common potential wiring COM has been written, and thus the pixel electrode (PE) is raised by capacitive coupling. At the same time, the voltage of the signal line (S1B) is written to one side of the capacitance CA of a pixel in the (n+1)th row, and the voltage (0 V) of the common potential wiring COM is written to another side of the capacitance CA. An operation of similarly repeating the driving sequentially is subsequently performed.

A description will be made with reference to drawings in the following.

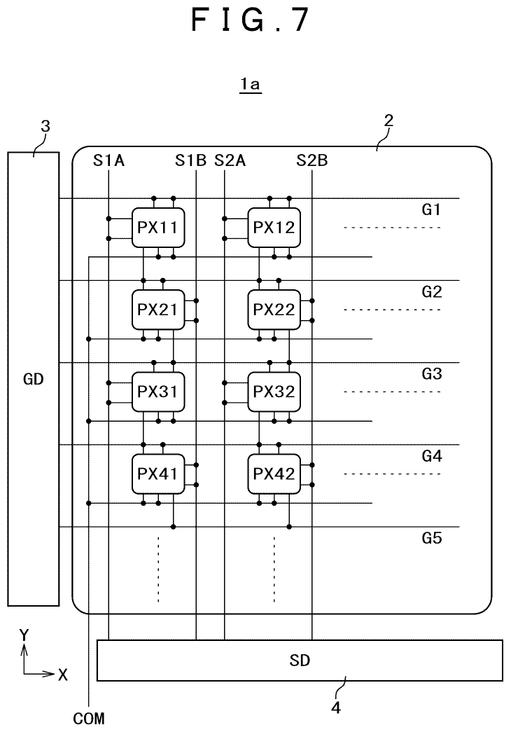

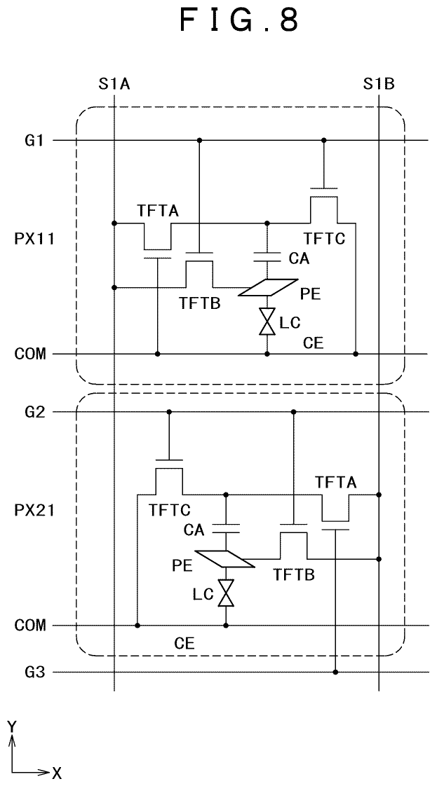

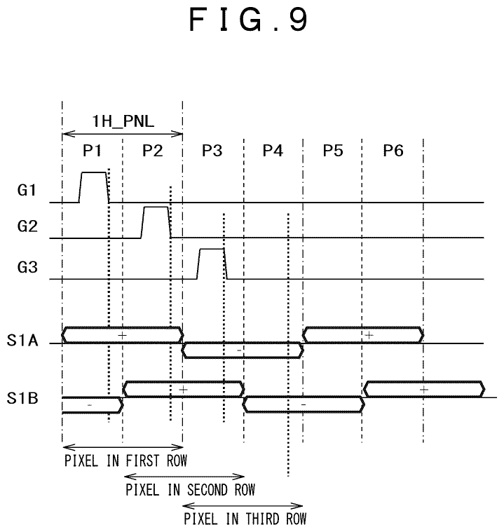

FIG. 7 is a diagram illustrating an example of a configuration of a display device according to the second embodiment. FIG. 8 is a diagram illustrating an example of a configuration of three pixels illustrated in FIG. 7. FIG. 9 is a diagram illustrating a timing diagram of the display device according to the second embodiment.

As illustrated in FIG. 7, the display device 1a includes a display area 2 in which a plurality of pixels PX (PX11, PX12, . . . , PX42) are arranged in a matrix manner (in the form of a matrix), a gate driving circuit (GD) 3, and a signal line driving circuit (SD) 4. The display area 2 may be reworded as a display panel.

The display area 2 includes the plurality of pixels PX and a plurality of scanning lines GL (a first scanning line G1, a second scanning line G2, a third scanning line G3, a fourth scanning line G4, a fifth scanning line G5, and the like) extending in the first direction X and arranged in the second direction Y intersecting the first direction X. The plurality of scanning lines GL are connected to the gate driving circuit (GD) 3, and are configured to be driven by the gate driving circuit 3.

In addition, the display area 2 includes a plurality of signal lines SL (a first signal line S1A, a second signal line S1B, a third signal line S2A, a fourth signal line S2B, and the like) extending in the second direction Y and arranged in the first direction X. The plurality of signal lines SL are connected to the signal line driving circuit 4, and are configured to be driven by the signal line driving circuit 4.

Common potential wiring COM is connected to each of the plurality of pixels PX, and is configured to supply a reference potential, for example, a ground potential (0 V).

An example of connections of the plurality of pixels PX to the scanning lines GL and the signal lines SL will be described as a representative example in the following.

The pixels PX11 and PX12 in a first row are connected to the scanning line G1 and the scanning line G2. The pixel PX11 is connected to the signal line S1A. The pixel PX12 is connected to the signal line S2A.

The pixels PX21 and PX22 in a second row are connected to the scanning line G2 and the scanning line G3. The pixel PX21 is connected to the signal line S1B. The pixel PX22 is connected to the signal line S2B.

The pixels PX31 and PX32 in a third row are connected to the scanning line G3 and the scanning line G4. The pixel PX31 is connected to the signal line S1A. The pixel PX32 is connected to the signal line S2A.

The pixels PX41 and PX42 in a fourth row are connected to the scanning line G4 and the scanning line G5. The pixel PX41 is connected to the signal line S1B. The pixel PX42 is connected to the signal line S2B.

That is, the second embodiment has such a characteristic configuration that in a certain pixel (for example, the first pixel PX11) and another pixel (for example, the second pixel PX21) adjacent in the second direction Y to the certain pixel (first pixel PX11) among the plurality of pixels PX, a connected signal line is the signal line S1A for the certain pixel (for example, the first pixel PX11), and is the signal line S1B, which is different from the signal line S1A, for the another pixel (for example, the second pixel PX21).

FIG. 8 illustrates, as a representative example, an example of a pixel configuration of the first pixel PX11 and the second pixel PX21 adjacent in the second direction Y to the first pixel PX11.

The first pixel PX11 includes a first transistor TFT-A, a second transistor TFT-B, a third transistor TFT-C, and a first common electrode CE and a first pixel electrode PE sandwiching a liquid crystal LC. The first common electrode CE is supplied with a reference potential, for example, a ground potential (0 V) from the common potential wiring COM.

A gate of the first transistor TFT-A is connected to the second scanning line G2. One of a source and a drain of the first transistor TFT-A is connected to the first signal line S1A. The other of the source and the drain of the first transistor TFT-A is connected to the first pixel electrode PE via a first capacitive element CA.

A gate of the second transistor TFT-B is connected to the first scanning line G1. One of a source and a drain of the second transistor TFT-B is connected to the first signal line S1A. The other of the source and the drain of the second transistor TFT-B is connected to the first pixel electrode PE.

A gate of the third transistor TFT-C is connected to the first scanning line G1. One of a source and a drain of the third transistor TFT-C is connected to the other of the source and the drain of the first transistor TFT-A. The other of the source and the drain of the third transistor TFT-C is connected to the first common electrode CE.

The second pixel PX21 includes a fourth transistor TFT-A, a fifth transistor TFT-B, a sixth transistor TFT-C, and a second common electrode CE and a second pixel electrode PE sandwiching the liquid crystal LC. The second common electrode CE is supplied with the reference potential of 0 V from the common potential wiring COM.

A gate of the fourth transistor TFT-A is connected to the third scanning line G3. One of a source and a drain of the fourth transistor TFT-A is connected to the second signal line S1B. The other of the source and the drain of the fourth transistor TFT-A is connected to the second pixel electrode PE via a second capacitive element CA.

A gate of the fifth transistor TFT-B is connected to the second scanning line G2. One of a source and a drain of the fifth transistor TFT-B is connected to the second signal line S1B. The other of the source and the drain of the fifth transistor TFT-B is connected to the second pixel electrode PE.

A gate of the sixth transistor TFT-C is connected to the second scanning line G2. One of a source and a drain of the sixth transistor TFT-C is connected to the other of the source and the drain of the fourth transistor TFT-A. The other of the source and the drain of the sixth transistor TFT-C is connected to the second common electrode CE.

Timings will be described with reference to FIG. 9. In FIG. 9, a sign − denotes negative polarity with respect to the reference potential, and a sign + denotes positive polarity with respect to the reference potential. In addition, one horizontal period (1H_PNL) of the display area 2 as a display panel includes a first half period P1 (referred to also as a first period P1) and a second half period P2 (referred to also as a second period P2). FIG. 9 depicts the first period P1, the second period P2 following the first period P1, a third period P3 following the second period P2, and a fourth period P4 following the third period P3. Also depicted following the fourth period are a fifth period P5 following the fourth period P4 and a sixth period P6 following the fifth period P5. The first period P1 and the second period P2 are set as a first horizontal period, for example. The third period P3 and the fourth period P4 are set as a second horizontal period, for example.

In the first period P1 and the second period P2, display data is written to a plurality of pixels in the first row (for example, the first pixel PX11). In the second period P2 and the third period P3, display data is written to a plurality of pixels in the second row (for example, the second pixel PX21). In the third period P3 and the fourth period P4, display data is written to a plurality of pixels in the third row (for example, the third pixel PX31). In the fourth period P4 and the fifth period P5, display data is written to a plurality of pixels in the fourth row (for example, the fourth pixel PX41). In the fifth period P5 and the sixth period P6, display data is written to a plurality of pixels in a fifth row (for example, a fifth pixel PX51). The following description will be made using the first pixel PX11 and the second pixel PX21 as representatives.

In the first period P1, the first scanning line G1 makes a transition from a low level (non-selected state) to a high level (selected state). The second scanning line G2 and the third scanning line G3 are at a low level. The second transistor TFT-B and the third transistor TFT-C of the first pixel PX11 are thereby both set in an on state. At this time, a voltage (+V1: for example, +6.1 V) is written to the first capacitive element CA of the first pixel PX11 from the first signal line S1A. Here, the voltage of the second signal line S1B is −V1, for example, −6.1 V. The first scanning line G1 thereafter makes a transition from the high level to the low level. The second transistor TFT-B and the third transistor TFT-C are thereby set in an off state.

In the second period P2, the second scanning line G2 makes a transition from a low level (non-selected state) to a high level (selected state). The first scanning line G1 and the third scanning line G3 are at a low level. The first transistor TFT-A of the first pixel PX11 is thereby set in an on state. At this time, a voltage (+V1: for example, +6.1 V) is written to the first capacitive element CA of the first pixel PX11 from the first signal line S1A. The voltage of the first pixel electrode PE is thereby, for example, raised (boosted) from +V1 (for example, +6.1 V) to +V2 (for example, +14 V). In addition, the fifth transistor TFT-B and the sixth transistor TFT-C of the second pixel PX21 are both set in an on state. At this time, a voltage (+V1: for example, +6.1 V) is written to the second capacitive element CA of the second pixel PX21 from the second signal line S1B. The second scanning line G2 thereafter makes a transition from the high level to the low level. The first transistor TFT-A, the fifth transistor TFT-B, and the sixth transistor TFT-C are thereby set in an off state.

In the third period P3, the third scanning line G3 makes a transition from a low level (non-selected state) to a high level (selected state). The first scanning line G1 and the second scanning line G2 are at a low level. The fourth transistor TFT-A of the second pixel PX21 is thereby set in an on state. At this time, a voltage (+V1: for example, +6.1 V) is written to the first capacitive element CA of the second pixel PX21 from the second signal line S1B. The voltage of the second pixel electrode PE is thereby, for example, raised (boosted) from +V1 (for example, +6.1 V) to +V2 (for example, +14 V). In addition, the transistor TFT-B and the transistor TFT-C of the third pixel PX31 are both set in an on state. At this time, a voltage (−V1: for example, −6.1 V) is written to the capacitive element CA of the third pixel PX31 from the first signal line S1A. The third scanning line G3 thereafter makes a transition from the high level to the low level. The fourth transistor TFT-A as well as the transistor TFT-B and the transistor TFT-C of the third pixel PX31 is thereby set in an off state.

In the fourth period P4, the fourth scanning line G4 makes a transition from a low level (non-selected state) to a high level (selected state). The transistor TFT-A of the third pixel PX31 is thereby set in an on state. A voltage (−V1: for example, −6.1 V) is written to the capacitive element CA of the third pixel PX31 from the first signal line S1A. The voltage of the third pixel electrode PE is thereby, for example, lowered (stepped down) from −V1 (for example, −6.1 V) to −V2 (for example, 14 V). In addition, the transistor TFT-B and the transistor TFT-C of the fourth pixel PX41 are both set in an on state. At this time, a voltage (−V1: for example, −6.1 V) is written to the capacitive element CA of the fourth pixel PX41 from the second signal line S1B. The fourth scanning line G4 thereafter makes a transition from the high level to the low level.

In the fifth period P5 and the sixth period P6, the operation as described above is repeated, so that display data is written to the plurality of pixels in the third row (for example, the third pixel PX31), the plurality of pixels in the fourth row (for example, the fourth pixel PX41), and the plurality of pixels in the fifth row (for example, the fifth pixel PX51).

Writing to each row of the display area 2 of the display device 1 is performed by the operation as described above.

Hence, a summary can be made as follows.

In the first period P1 and the second period P2, a voltage of positive polarity with respect to the reference potential is continuously applied to the first signal line S1A.

In the third period P3 and the fourth period P4, a voltage of negative polarity with respect to the reference potential is continuously applied to the first signal line S1A.

In the first period P1, a potential of negative polarity with respect to the reference potential is applied to the second signal line S1B.

In the second period P2 and the third period P3, a voltage of positive polarity with respect to the reference potential is continuously applied to the second signal line S1B.

In the fourth period P4, a voltage of negative polarity with respect to the reference potential is applied to the second signal line S1B.

In the first period P1, the first scanning line G1 makes a transition in order of a low level, a high level, and the low level.

In the second period P2, the second scanning line G2 makes a transition in order of a low level, a high level, and the low level.

In the third period P3, the third scanning line G3 makes a transition in order of a low level, a high level, and the low level.

Thus, first half driving of the pixels in the (n+1)th row is made to coincide simultaneously with the second half time of one horizontal period of the pixels in the (n)th row, and therefore a time for the pixels of the y rows as a whole can be made to be (y+1)×H=(y×H)+H, that is, made to be substantially equal to that of the ordinary pixels with a mere increase of H.

With the conventional boosting pixels, one horizontal period takes twice the time of the ordinary pixels. Thus, the display device in which there are y rows for the entire screen needs a double time, that is, (y×H×2). This means that the number of pixel rows that can be driven in a time of one frame is halved.

In the first embodiment and the second embodiment, one apparent horizontal period is equal to that of the ordinary pixels. In the second embodiment, upper and lower pixels adjacent to each other share a scanning line, and therefore the number of scanning lines per pixel can be halved to be equivalent to one. Hence, the second embodiment, which provides a higher aperture ratio than the first embodiment, has an advantage over the first embodiment.

Thus, it is possible to implement pixels including a boosting circuit without reducing the number of pixels (rows), increase the amplitude of the pixel electrode PE with respect to the output amplitude of the source driver IC (signal line driving circuit 4), and consequently raise the voltage applied to the liquid crystal LC. In addition, a transparent display of high display performance that uses a general-purpose source driver IC can be provided.

### (Transparent Display)

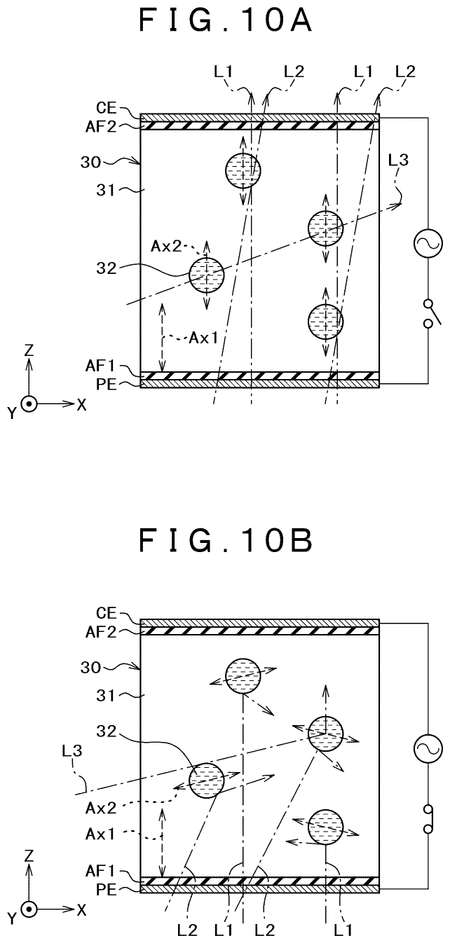

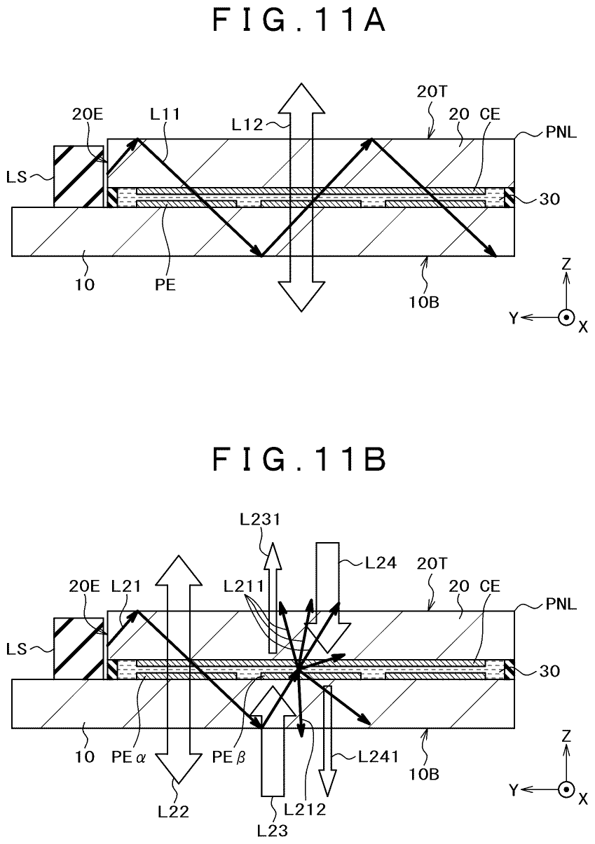

A transparent display will next be described with reference to FIG. 10A, FIG. 10B, FIG. 11A, and FIG. 11B. FIG. 10A is a diagram schematically illustrating a liquid crystal layer 30 in a transparent state. FIG. 10B is a diagram schematically illustrating the liquid crystal layer 30 in a scattering state. FIG. 11A is a sectional view illustrating a display panel PNL in a case where the liquid crystal layer 30 is in the transparent state. FIG. 11B is a sectional view illustrating the display panel PNL in a case where the liquid crystal layer 30 is in the scattering state.

Incidentally, in the following description, the display device 1 or 1a as a transparent display will be described as the display panel, and the liquid crystal LC will be described as the liquid crystal layer 30. In the following, a description will be made of an example of a configuration of the display device including the liquid crystal layer 30 as a PDLC layer.

FIG. 10A is a diagram schematically illustrating the liquid crystal layer 30 in the transparent state. As illustrated in FIG. 10A, the liquid crystal layer 30 includes a liquid crystalline polymer 31 and liquid crystalline molecules 32. The liquid crystalline polymer 31 is, for example, obtained by polymerizing liquid crystalline monomers in a state of being aligned in a predetermined direction by an alignment regulating force of alignment films AF1 and AF2. The liquid crystalline molecules 32 are dispersed within the liquid crystalline monomers, and are aligned in a predetermined direction depending on the alignment direction of the liquid crystalline monomers when the liquid crystalline monomers are polymerized. Incidentally, the alignment films AF1 and AF2 may be horizontal alignment films that align the liquid crystalline monomers and the liquid crystalline molecules 32 along an X-Y plane defined by the first direction X and the second direction Y, or may be vertical alignment films that align the liquid crystalline monomers and the liquid crystalline molecules 32 along a third direction Z.

The liquid crystalline molecules 32 may be of a positive type having a positive dielectric anisotropy, or may be of a negative type having a negative dielectric anisotropy. The liquid crystalline polymer 31 and the liquid crystalline molecules 32 each have equal optical anisotropy. Alternatively, the liquid crystalline polymer 31 and the liquid crystalline molecules 32 each have substantially equal refractive index anisotropy. That is, the liquid crystalline polymer 31 and the liquid crystalline molecules 32 are substantially equal to each other in terms of an ordinary refractive index and an extraordinary refractive index. Incidentally, with regard to both of the ordinary refractive index and the extraordinary refractive index, the respective values of the liquid crystalline polymer 31 and the liquid crystalline molecules 32 do not have to coincide with each other completely, and differences caused by a manufacturing error or the like are tolerated. In addition, each of the liquid crystalline polymer 31 and the liquid crystalline molecules 32 has different responsiveness to an electric field. That is, the responsiveness of the liquid crystalline polymer 31 to an electric field is lower than the responsiveness of the liquid crystalline molecules 32 to an electric field.

An example illustrated in FIG. 10A corresponds to, for example, a state in which no voltage is applied to the liquid crystal layer 30 (state in which a potential difference between the pixel electrode PE and the common electrode CE is zero) or a state in which a second transparent voltage to be described later is applied to the liquid crystal layer 30.

As illustrated in FIG. 10A, an optical axis Ax1 of the liquid crystalline polymer 31 and an optical axis Ax2 of a liquid crystalline molecule 32 are parallel with each other. In the illustrated example, the optical axis Ax1 and the optical axis Ax2 are both parallel with the third direction Z. The optical axes in this case correspond to a line parallel with the traveling direction of such light rays that the refractive index is one value irrespective of a polarization direction.

As described above, the liquid crystalline polymer 31 and the liquid crystalline molecules 32 have substantially equal refractive index anisotropy, and the optical axes Ax1 and Ax2 are parallel with each other. There is thus little refractive index difference between the liquid crystalline polymer 31 and the liquid crystalline molecules 32 in all directions including the first direction X, the second direction Y, and the third direction Z. Therefore, light L1 that has entered the liquid crystal layer 30 in the third direction Z passes through without being substantially scattered within the liquid crystal layer 30. The liquid crystal layer 30 can maintain the parallelism of the light L1. Similarly, light L2 and L3 that has entered in an oblique direction inclined with respect to the third direction Z is hardly scattered within the liquid crystal layer 30. High transparency is therefore obtained. The state illustrated in FIG. 10A will be referred to as a “transparent state.”

FIG. 10B is a diagram schematically illustrating the liquid crystal layer 30 in the scattering state. As illustrated in FIG. 10B, as described above, the responsiveness of the liquid crystalline polymer 31 to an electric field is lower than the responsiveness of the liquid crystalline molecules 32 to an electric field. Therefore, in a state in which a higher voltage (scattering voltage to be described later) than each of the above-described second transparent voltage and a first transparent voltage to be described later is applied to the liquid crystal layer 30, the alignment direction of the liquid crystalline molecules 32 changes according to the electric field while the alignment direction of the liquid crystalline polymer 31 hardly changes. That is, as illustrated in the figure, the optical axis Ax2 is inclined with respect to the third direction Z while the optical axis Ax1 is almost parallel with the third direction Z. The optical axes Ax1 and Ax2 therefore intersect each other. Hence, a large refractive index difference occurs between the liquid crystalline polymer 31 and the liquid crystalline molecules 32 in all directions including the first direction X, the second direction Y, and the third direction Z. The light L1 to L3 that has entered the liquid crystal layer 30 is thereby scattered within the liquid crystal layer 30. The state illustrated in FIG. 10B will be referred to as a “scattering state.”

The gate driving circuit GD and the signal line driving circuit SD as a driving unit switch the liquid crystal layer 30 to at least one of the transparent state and the scattering state.

FIG. 11A is a sectional view illustrating the display panel PNL in a case where the liquid crystal layer 30 is in the transparent state. As illustrated in FIG. 11A, illuminating light L11 emitted from a light emitting element LS enters the display panel PNL from an end portion 20E, and propagates through a transparent substrate 20, a liquid crystal layer 30, a transparent substrate 10, and the like. In the case where the liquid crystal layer 30 is in the transparent state, the illuminating light L11 is hardly scattered in the liquid crystal layer 30, and therefore hardly leaks out from a lower surface 10B of the transparent substrate 10 and an upper surface 20T of the transparent substrate 20. Incidentally, the transparent substrate 10 can be formed by, for example, a cover glass and an array substrate provided on the upper side of the cover glass. The transparent substrate 20 can be formed by a transparent light guide plate and a counter substrate that is provided to the lower side of the transparent light guide plate and is opposed to the array substrate. The liquid crystal layer 30 is provided between the array substrate and the counter substrate.

Extraneous light L12 that has entered the display panel PNL passes through while hardly scattered by the liquid crystal layer 30. That is, extraneous light L12 that has entered the display panel PNL from the lower surface 10B is transmitted to the upper surface 20T, and extraneous light L12 that has entered from the upper surface 20T is transmitted to the lower surface 10B. Therefore, when a user observes the display panel PNL from the upper surface 20T side, the user can view a background on the lower surface 10B side through the display panel PNL. Similarly, when the display panel PNL is observed from the lower surface 10B side, a background on the upper surface 20T side can be viewed through the display panel PNL.

FIG. 11B is a sectional view illustrating the display panel PNL in a case where the liquid crystal layer 30 is in the scattering state. As illustrated in FIG. 11B, illuminating light L21 emitted from the light emitting element LS enters the display panel PNL from the end portion 20E, and propagates through the transparent substrate 20, the liquid crystal layer 30, the transparent substrate 10, and the like. In the illustrated example, the liquid crystal layer 30 between a pixel electrode PEα and the common electrode CE (liquid crystal layer to which a voltage applied between the pixel electrode PEα and the common electrode CE is applied) is in the transparent state. The illuminating light L21 is therefore hardly scattered in an area of the liquid crystal layer 30 which area faces the pixel electrode PEα. On the other hand, the liquid crystal layer 30 between a pixel electrode PEβ and the common electrode CE (liquid crystal layer to which a voltage applied between the pixel electrode PEβ and the common electrode CE is applied) is in the scattering state. The illuminating light L21 is therefore scattered in an area of the liquid crystal layer 30 which area faces the pixel electrode PEβ. Partial scattered light L211 of the illuminating light L21 is emitted from the upper surface 20T to the outside. In addition, partial scattered light L212 of the illuminating light L21 is emitted from the lower surface 10B to the outside.

At a position coinciding with the pixel electrode PEα, as with the extraneous light L12 illustrated in FIG. 11A, extraneous light L22 that has entered the display panel PNL passes through while hardly scattered by the liquid crystal layer 30. At a position coinciding with the pixel electrode PEβ, partial light L231 of extraneous light L23 that has entered from the lower surface 10B is transmitted from the upper surface 20T after the extraneous light L23 is scattered by the liquid crystal layer 30. In addition, partial light L241 of extraneous light L24 that has entered from the upper surface 20T is transmitted from the lower surface 10B after the extraneous light L24 is scattered by the liquid crystal layer 30.

Therefore, when the display panel PNL is observed from the upper surface 20T side, the color of the illuminating light L21 can be viewed at the position coinciding with the pixel electrode PEβ. In addition, because the partial extraneous light L231 passes through the display panel PNL, the background on the lower surface 10B side can also be viewed through the display panel PNL. Similarly, when the display panel PNL is observed from the lower surface 10B side, the color of the illuminating light L21 can be viewed at the position coinciding with the pixel electrode PEβ. In addition, because the partial extraneous light L241 passes through the display panel PNL, the background on the upper surface 20T side can also be viewed through the display panel PNL. Incidentally, at the position coinciding with the pixel electrode PEα, the liquid crystal layer 30 is in the transparent state, so that the background can be viewed through the display panel PNL while the color of the illuminating light L21 is hardly viewed.

All of display devices that can be implemented by those skilled in the art by making design changes as appropriate on the basis of the display devices described above as embodiments of the present disclosure also belong to the scope of the present disclosure as long as including the spirit of the present disclosure.

A person skilled in the art can conceive various kinds of modification examples and correction examples in a category of ideas of the present disclosure. It is therefore to be understood that those modification examples and correction examples also belong to the scope of the present disclosure. For example, embodiments obtained by a person skilled in the art by adding, deleting, or making design changes in constituent elements or adding, omitting, or making condition changes in processes as appropriate in each of the foregoing embodiments are included in the scope of the present disclosure as long as including the spirit of the present disclosure.

In addition, it is to be understood that other actions and effects that are produced by modes described in the present embodiments and that are obvious from the description of the present specification or can be conceived as appropriate by those skilled in the art are naturally produced by the present disclosure.

Various disclosures can be formed by appropriate combinations of a plurality of constituent elements disclosed in the foregoing embodiments. For example, a few constituent elements may be deleted from all of the constituent elements illustrated in the embodiments. Further, constituent elements of the different embodiments may be combined with each other as appropriate.

What is claimed is:

1. A display device comprising:
a plurality of pixels arranged in a matrix manner;
a first scanning line, a second scanning line, a third scanning line, and a fourth scanning line extending in a first direction and arranged in a second direction intersecting the first direction; and
a first signal line and a second signal line extending in the second direction and arranged in the first direction,
the plurality of pixels including a first pixel and a second pixel that is adjacent in the second direction to the first pixel,
the first pixel including a first transistor, a second transistor, a third transistor, and a first common electrode and a first pixel electrode sandwiching a liquid crystal, the first common electrode being supplied with a reference potential,
a gate of the first transistor being connected to the second scanning line, one of a source and a drain of the first transistor being connected to the first signal line, and other one of the source and the drain of the first transistor being connected to the first pixel electrode via a first capacitive element,
a gate of the second transistor being connected to the first scanning line, one of a source and a drain of the second transistor being connected to the first signal line, and other one of the source and the drain of the second transistor being connected to the first pixel electrode,
a gate of the third transistor being connected to the first scanning line, one of a source and a drain of the third transistor being connected to other one of the source and the drain of the first transistor, and other one of the source and the drain of the third transistor being connected to the first common electrode,
the second pixel including a fourth transistor, a fifth transistor, a sixth transistor, and a second common electrode and a second pixel electrode sandwiching the liquid crystal, the second common electrode being supplied with the reference potential,
a gate of the fourth transistor being connected to the fourth scanning line, one of a source and a drain of the fourth transistor being connected to the second signal line, and other one of the source and the drain of the fourth transistor being connected to the second pixel electrode via a second capacitive element,
a gate of the fifth transistor being connected to the third scanning line, one of a source and a drain of the fifth transistor being connected to the second signal line, and other one of the source and the drain of the fifth transistor being connected to the second pixel electrode, and
a gate of the sixth transistor being connected to the third scanning line, one of a source and a drain of the sixth transistor being connected to other one of the source and the drain of the fourth transistor, and other one of the source and the drain of the sixth transistor being connected to the second common electrode.

2. The display device according to claim 1, wherein
the display device has a first period, a second period following the first period, a third period following the second period, and a fourth period following the third period,
in the first period and the second period, a voltage of positive polarity with respect to the reference potential is applied to the first signal line and the second signal line,
in the third period and the fourth period, a voltage of negative polarity with respect to the reference potential is applied to the first signal line and the second signal line,
in the first period, the first scanning line and the third scanning line make a transition in order of a low level, a high level, and a low level, and
in the second period, the second scanning line and the fourth scanning line make a transition in order of a low level, a high level, and a low level.

3. The display device according to claim 1, wherein
the liquid crystal is a polymer dispersed liquid crystal.

4. A display device comprising:
a plurality of pixels arranged in a matrix manner;
a first scanning line, a second scanning line, and a third scanning line extending in a first direction and arranged in a second direction intersecting the first direction; and
a first signal line and a second signal line extending in the second direction and arranged in the first direction,
the plurality of pixels including a first pixel and a second pixel arranged so as to be adjacent to each other in the second direction,
the first pixel including a first transistor, a second transistor, a third transistor, and a first common electrode and a first pixel electrode sandwiching a liquid crystal, the first common electrode being supplied with a reference potential,
a gate of the first transistor being connected to the second scanning line, one of a source and a drain of the first transistor being connected to the first signal line, and other one of the source and the drain of the first transistor being connected to the first pixel electrode via a first capacitive element,
a gate of the second transistor being connected to the first scanning line, one of a source and a drain of the second transistor being connected to the first signal line, and other one of the source and the drain of the second transistor being connected to the first pixel electrode,
a gate of the third transistor being connected to the first scanning line, one of a source and a drain of the third transistor being connected to other one of the source and the drain of the first transistor, and other one of the source and the drain of the third transistor being connected to the first common electrode,
the second pixel including a fourth transistor, a fifth transistor, a sixth transistor, and a second common electrode and a second pixel electrode sandwiching the liquid crystal, the second common electrode being supplied with the reference potential,
a gate of the fourth transistor being connected to the third scanning line, one of a source and a drain of the fourth transistor being connected to the second signal line, and other one of the source and the drain of the fourth transistor being connected to the second pixel electrode via a second capacitive element,
a gate of the fifth transistor being connected to the second scanning line, one of a source and a drain of the fifth transistor being connected to the second signal line, and other one of the source and the drain of the fifth transistor being connected to the second pixel electrode, and
a gate of the sixth transistor being connected to the second scanning line, one of a source and a drain of the sixth transistor being connected to other one of the source and the drain of the fourth transistor, and other one of the source and the drain of the sixth transistor being connected to the second common electrode.

5. The display device according to claim 4, wherein
the display device has a first period, a second period following the first period, a third period following the second period, and a fourth period following the third period,
in the first period and the second period, a voltage of positive polarity with respect to the reference potential is continuously applied to the first signal line,
in the third period and the fourth period, a voltage of negative polarity with respect to the reference potential is continuously applied to the first signal line,
in the first period, a potential of negative polarity with respect to the reference potential is applied to the second signal line,
in the second period and the third period, a voltage of positive polarity with respect to the reference potential is continuously applied to the second signal line,
in the fourth period, a voltage of negative polarity with respect to the reference potential is applied to the second signal line,
in the first period, the first scanning line makes a transition in order of a low level, a high level, and a low level,
in the second period, the second scanning line makes a transition in order of a low level, a high level, and a low level, and
in the third period, the third scanning line makes a transition in order of a low level, a high level, and a low level.

6. The display device according to claim 4, wherein
the liquid crystal is a polymer dispersed liquid crystal.
